(19) United States
(12) Patent Application Publication
(10) Pub. No.: US 2013/0138969 A1
(43) Pub. Date: May 30, 2013

(54) PREVENTING GLITCHING OF A FIRMWARE IMAGE USING ONE OR MORE LAYERS OF RANDOMNESS

(71) Applicant: Mocana Corporation, San Francisco, CA (US)

(72) Inventor: James BLAISDELL, Novato, CA (US)

(73) Assignee: MOCANA CORPORATION, San Francisco, CA (US)

(21) Appl. No.: 13/687,885

(22) Filed: Nov. 28, 2012

Related U.S. Application Data
(60) Provisional application No. 61/564,149, filed on Nov. 28, 2011.

(51) Int. Cl. G06F 21/50

(52) U.S. Cl. CPC G06F 21/50
USPC 713/187

(57) ABSTRACT

Layers and elements of randomness are introduced to the firmware image comparison process to prevent hackers from glitching or tampering with the firmware image on a computing device. A hash function is applied to the firmware image thereby obtaining a first hash value. Random blocks of data are selected from the firmware image before it is hashed. Each or some of the random blocks of the firmware image are hashed thereby providing a hash value for the random blocks. The hash values are combined to derive a second hash value. The first hash value and the second hash value are combined to derive a final hash value. The final hash value is digitally signed and compared to a stored hash value. If the two match, a random non-zero value is stored in the relevant register.

### CROSS-REFERENCE TO RELATED APPLICATIONS

This application claims priority under U.S.C. §119(e) to U.S. Provisional Patent Application Ser. No. 61/564,149 entitled “ANTI-GLITCHING METHOD USING ONE OR MORE LAYERS OF RANDOMNESS”, filed Nov. 28, 2011, the entirety of which is incorporated by reference herein for all purposes.

### TECHNICAL FIELD

The present invention relates generally to software and preventing software tampering. More specifically, it relates to preventing unauthorized entities from tampering with firmware or software executing on a computing device.

### BACKGROUND OF THE INVENTION

Glitching is a technique used by hackers and unauthorized entities to tamper or infect a firmware image of an application on a computing device and making the CPU of a device execute the firmware as if an authentic and authorized version of the firmware is on the device when it powers on. The device then ends up executing the tampered, hacked, or unauthorized version of the firmware. This allows someone to use the device in an improper way, such as play pirated versions of video games, allow a different operating system to execute, sniff passwords, credit card numbers, and the like.

Presently, an image of the firmware is hashed and digitally signed using a private key. This secure image is compared to an image stored in flash memory on the CPU. When a device powers on, the CPU verifies that the firmware has not been altered. It may scan the firmware image and calculate a hash (SHA-1 or SHA-2). This hash value is compared to a hash value stored in the flash memory. It also verifies the digital signature. In this manner, the CPU can detect the slightest tampering, e.g., a change in one byte.

It is now possible for hackers to make changes or a change to the firmware or replace it completely and still have a successful CPU firmware image comparison (i.e., one that will not fail). Hackers are able to precisely time a failure or glitch so that registers are reset (e.g., to 0) at the right moment which leads the CPU to think that the firmware is fine. It would be desirable to have security software that is resistant to this type of attack. That is, be immune to glitching.

### SUMMARY OF THE INVENTION

One aspect of the invention is a method of preventing tampering of a firmware image on a computing device. A hash function is applied to the firmware image thereby obtaining a first hash value. Random blocks of data are selected from the firmware image. The blocks of data may be the same size and a bit map table may be used to keep track of which random blocks are selected from the firmware image. Each or some of the random blocks of the firmware image are hashed thereby providing a hash value for each or some of the random blocks. The hash values are combined to derive a second hash value. For example, the hash values may be combined using an XOR function. The first hash value and the second hash value are combined to derive a final hash value. The final hash value is digitally signed and compared to a stored hash value. If the two match, a random non-zero value is stored in the relevant register.

In another embodiment, the random blocks selected from the firmware image are both real, as they all are in the first embodiment, and some are fake or contain false data. This introduces another element of randomness into the firmware verification image to prevent glitching. The hash values of the random blocks of real data are combined to create a second hash value. In another embodiment, the hash values of the real data and the fake data are combined to create the second hash value.

### BRIEF DESCRIPTION OF THE DRAWINGS

The invention and the advantages thereof may best be understood by reference to the following description taken in conjunction with the accompanying drawings in which:

FIG. 1 is a flow diagram of processes for preventing glitching of firmware on a computing device in accordance with various embodiments; and

FIGS. 2A and 2B are diagrams of a computing device suitable for implementing embodiments of the present invention.

In the drawings, like reference numerals are sometimes used to designate like structural elements. It should also be appreciated that the depictions in the figures are diagrammatic and not to scale.

### DETAILED DESCRIPTION OF THE INVENTION

Example embodiments of an application security process and system are described. These examples and embodiments are provided solely to add context and aid in the understanding of the invention. Thus, it will be apparent to one skilled in the art that the present invention may be practiced without some or all of the specific details described herein. In other instances, well-known concepts have not been described in detail in order to avoid unnecessarily obscuring the present invention. Other applications and examples are possible, such that the following examples, illustrations, and contexts should not be taken as definitive or limiting either in scope or setting. Although these embodiments are described in sufficient detail to enable one skilled in the art to practice the invention, these examples, illustrations, and contexts are not limiting, and other embodiments may be used and changes may be made without departing from the spirit and scope of the invention.

The present invention describes methods of preventing a technique referred to as glitching. Glitching is used to tamper with a firmware image of an application and making the CPU of a device execute as if an authentic and authorized version of the firmware is executing on the device when the device powers on and executes the tampered, hacked, or unauthorized version of the firmware may be executing. This may allow someone to use the device in an improper way (e.g., play pirated versions of video games allow a different operating system to execute, sniff passwords, credit card numbers, and the like).

As is known in the art, an image of the firmware is hashed and digitally signed using a private key. This secure image is compared to an image stored in flash memory on the CPU. When a device powers on, the CPU verifies that the firmware has not been altered. It may scan the firmware image and calculate a hash (SHA-1 or SHA-2). This hash value is compared to a hash value stored in the flash memory. It also verifies the digital signature. In this manner, the CPU can detect the slightest tampering, e.g., a change in one byte.

It is now possible for hackers to make changes or a change to the firmware or replace it completely and still have a successful CPU firmware image comparison (i.e., one that will not fail). One of the elements used in glitching is timing. Hackers are able to precisely time a failure or glitch so that registers are reset (e.g., to 0) at the right moment which leads the CPU to think that the firmware is fine. It would be desirable to have security software that is resistant to this type of attack. That is, be immune to glitching.

In one embodiment, one or more elements of randomness are added to the firmware image hash calculation and into the digital signature. For example, randomness may be injected with respect to timing. Hackers are watching (examining) the device boot up or power on process from the beginning and often rely on timing. For example, they may measure how much time it takes to complete a hash or when the CPU does its comparison.

Presently, if hash values match, a “0” value is returned from the comparison and the device continues with boot up. Hackers may start a counter and at a certain counter value, they may inject a “0” value into the register. One of the objectives, as noted, is to make it unpredictable for hackers so they do not know when to populate registers with tampered values. One way to make the process unpredictable is to add randomness to the timing (e.g., the time it takes to perform functions or tasks) and other factors. Another factor may be to return a non-zero value when the comparison succeeds instead of zero, conversely, that a returned value of “0” means that there was a memory compare failure (“dead” state), otherwise continue. The number returned should be random and unpredictable.

In one embodiment, there may be two interlaced hash functions. One hash function performs the normal hash function and the firmware is scanned in a conventional manner as described above. In one embodiment, the hash value from this function may be added or combined in some manner with another hash value. The other interlaced hash function takes randomly selected blocks (each of a specific number of bytes) from the firmware image and hashes it. In one embodiment, a bit map may be used to keep track of which blocks have been taken or selected (randomly) and hashed. This will prevent taking a hash value of a block more than once. Depending on the size of the blocks, this bit map may be small (e.g., 128 bytes). The hash values of the randomly selected blocks may be XOR'd together. The result of this series of logic operations may then be added to the normal hash value. The sum is then compared to the hash value stored in the CPU flash.

In one embodiment, to add another layer of randomness (unpredictability), some of the blocks that are grabbed may be fake blocks. A hash value is still taken of the fake block, but the value is not used in the XOR operation or in deriving the final hash value used for comparison. However, the values may still be used in an XOR operation to mislead hackers, but the value of the XOR operations involving the fake blocks are not used for anything meaningful. By using authentic and fake blocks from the firmware image, hackers observing the system will not know how the hash value is determined. This is important because they may be able to “break” the random number generator to determine random values used in the process (e.g., memory comparison success value, noted above). For example, the other random factors in the process may be the time it takes to calculate the hash values and the random manner in which the hash values are interlaced (interlaced hash functions), as a result of having authentic and fake blocks taken from the firmware image. The bit map table may be used to keep track internally of which blocks are genuine and which are fake. For example, only real ones may be recorded in the bit map table.

The final hash value derived from adding the two interlaced hash values is digitally signed using a private key and then compared to the firmware image digitally signed value that is stored in CPU flash memory. If the comparison is successful, then, as noted, a non-zero value is returned indicating that the firmware has not been tampered with.

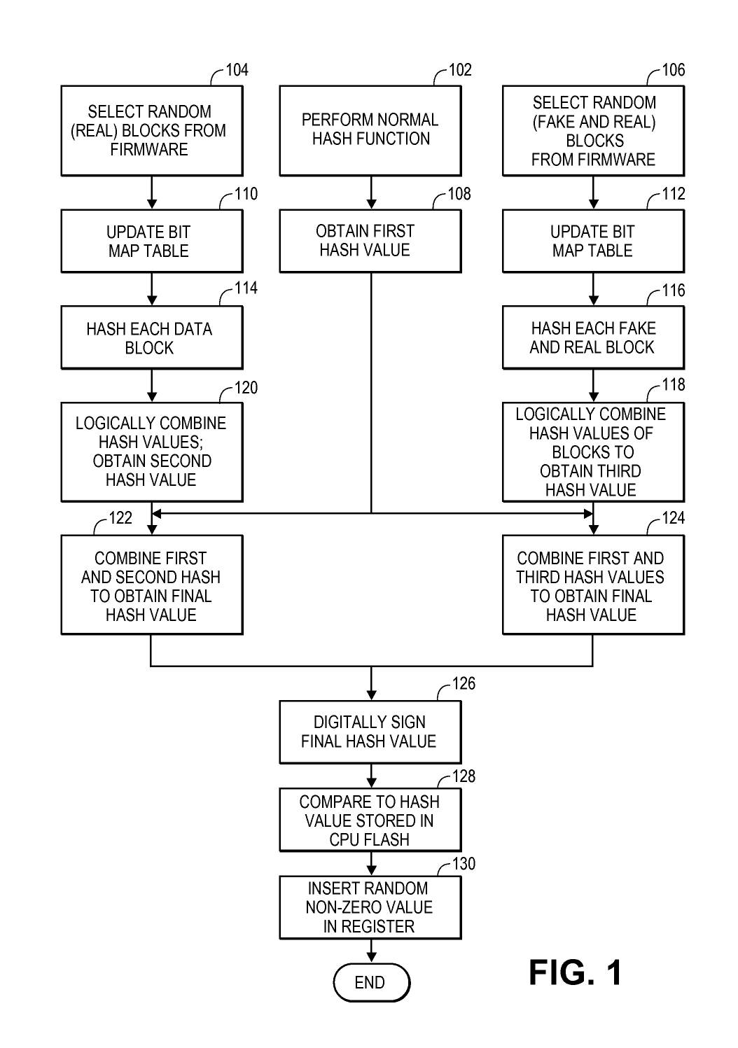

FIG. 1 is a flow diagram of processes for preventing glitching of firmware on a computing device in accordance with various embodiments. The steps described in the processes are also described above. There are two different processes described in the flow diagram. One involves using only real, randomly selected blocks of data from the firmware and the other involves real and fake blocks of firmware data. Each process requires performing a normal hashing function of the firmware as shown in step 102. Here a conventional hash is taken of the entire firmware image. At step 108 a first hash value is obtained from the hash function. This first hash value is used with other hash values as described below.

In one embodiment, at step 104 random blocks of firmware data are selected from the firmware image. The blocks may be of the same size and may be selected using a random number generator. A bit map table may be maintained by the CPU to keep track of which blocks of data in the firmware image are selected. At step 110 this bit map table is updated to reflect which blocks are selected. Other mechanisms may be used to keep track of which blocks are selected. At step 114 each selected block is hashed using a hash function, such as the hash function performed at step 102. At step 120 the individual hash functions are combined, in one embodiment, logically combined, such as an XOR operation, to obtain a second hash value. In other embodiments, other logical operations may be performed to combine the hash values. In other embodiments, a subset of the hash values may be used to derive the second hash value.

Before continuing the description of this embodiment, it is helpful to describe the other embodiment starting at step 106. At step 106 blocks of data from the firmware image are selected randomly as in step 104. However, some of the blocks are real and some are fake (i.e., do not contain actual data from the image). At step 112 a bit map table is updated to reflect which (real) blocks of data are selected from the firmware image. At step 116 each of the blocks are hashed, including the fake one. In other embodiments, only specific blocks are hashed. At step 118, the hash values from step 116 are logically combined to create a third hash value. In one embodiment, only the hash values of the real data blocks are logically combined.

Returning to step 120, where a second hash value is obtained, at step 122 the first hash value (from the normal hash function) and the second hash valued are combined, for example, added, to obtain a final hash value. Similarly, at step 124, after step 118, the first hash value is combined with the third hash value to obtain a final hash value. In each embodiment, the final hash value will be different because the real data blocks being hashed and logically combined are different. At step 126 the final hash value is digitally signed using a private key. At step 128 this digitally signed final hash value is compared to the hash value stored in the CPU flash memory. If the values match at step 128, in one embodiment, a random non-zero value is inserted into the appropriate register to indicate that the firmware image has not been tampered with. If they do not match, a zero value can be stored in the register.

This process for adding randomness to the timing and to other aspects of deriving the digitally signed hash value may be incorporated into existing security products and prevents the ability of hackers to glitch the firmware image and use a device for malevolent and unintended purposes.

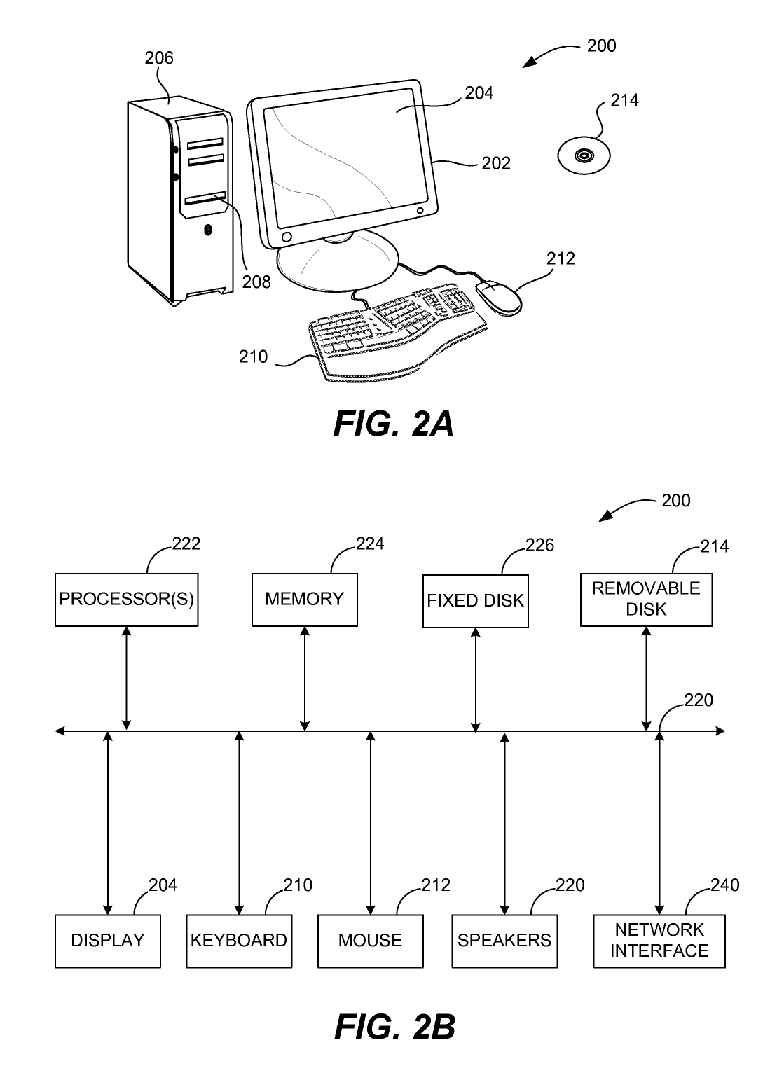

FIGS. 2A and 2B illustrate a generic computing system 200, such as a mobile device, suitable for implementing specific embodiments of the present invention. Some of the devices that can be used in the present invention may have other features or components that are not shown in FIGS. 2A and 2B and not all the components shown in these figures (e.g., the keyboard) are needed for implementing the present invention. As such, FIG. 2A shows one possible physical implementation of a computing system as this term is broadly defined.

In one embodiment, system 200 includes a display or screen 204. This display may be in the same housing as system 200. It may also have a keyboard 210 that is shown on display 204 (i.e., a virtual keyboard) or may be a physical component that is part of the device housing. It may have various ports such as HDMI or USB ports (not shown). Computer-readable media that may be coupled to device 200 may include USB memory devices and various types of memory chips, sticks, and cards.

FIG. 2B is an example of a block diagram for computing system 200. Attached to system bus 220 is a variety of subsystems. Processor(s) 222 are coupled to storage devices including memory 224. Memory 224 may include random access memory (RAM) and read-only memory (ROM). As is well known in the art, ROM acts to transfer data and instructions uni-directionally to the CPU and RAM are used typically to transfer data and instructions in a bi-directional manner. Both of these types of memories may include any suitable of the computer-readable media described below. A fixed disk 226 is also coupled bi-directionally to processor 222; it provides additional data storage capacity and may also include any of the computer-readable media described below. Fixed disk 226 may be used to store programs, data and the like and is typically a secondary storage medium that is slower than primary storage. It will be appreciated that the information retained within fixed disk 226, may, in appropriate cases, be incorporated in standard fashion as virtual memory in memory 224.

Processor 222 is also coupled to a variety of input/output devices such as display 204 and network interface 240. In general, an input/output device may be any of: video displays, keyboards, microphones, touch-sensitive displays, tablets, styluses, voice or handwriting recognizers, biometrics readers, or other devices. Processor 222 optionally may be coupled to another computer or telecommunications network using network interface 240. With such a network interface, it is contemplated that the CPU might receive information from the network, or might output information to the network in the course of performing the above-described method steps. Furthermore, method embodiments of the present invention may execute solely upon processor 222 or may execute over a network such as the Internet in conjunction with a remote processor that shares a portion of the processing.

In addition, embodiments of the present invention further relate to computer storage products with a computer-readable medium that have computer code thereon for performing various computer-implemented operations. The media and computer code may be those specially designed and constructed for the purposes of the present invention, or they may be of the kind well known and available to those having skill in the computer software arts. Examples of computer-readable media include, but are not limited to: magnetic media such as hard disks, floppy disks, and magnetic tape; optical media such as CD-ROMs and holographic devices; magneto-optical media such as floptical disks; and hardware devices that are specially configured to store and execute program code, such as application-specific integrated circuits (ASICs), programmable logic devices (PLDs) and ROM and RAM devices. Examples of computer code include machine code, such as produced by a compiler, and files containing higher-level code that are executed by a computer using an interpreter.

Although illustrative embodiments and applications of this invention are shown and described herein, many variations and modifications are possible which remain within the concept, scope, and spirit of the invention, and these variations would become clear to those of ordinary skill in the art after perusal of this application. Accordingly, the embodiments described are to be considered as illustrative and not restrictive, and the invention is not to be limited to the details given herein, but may be modified within the scope and equivalents of the appended claims.

What we claim is:

1. A method of preventing tampering of a firmware image on a computing device, the method comprising:
obtaining a first hash value of the firmware image;
selecting random blocks of data from the firmware image;
hashing the random block of firmware image data, thereby obtaining a hash value for each random block;
combining the hash values thereby deriving a second hash value;
combining the first hash value and the second hash value to obtain a final hash value;
digitally signing the final hash value; and
comparing the final hash value with a stored hash value.

2. A method as recited in claim 1 further comprising:
inserting a non-zero value in a register on the computing device if the final hash value is the same as the stored hash value.

3. A method as recited in claim 1 further comprising:
inserting a zero in a register on the computing device if the final hash value is not the same as the stored hash value.

4. A method as recited in claim 1 further comprising:
updating a bit map table to indicate the random blocks of data of the firmware image that were selected.

5. A method as recited in claim 1 wherein the hash values are logically combined using an XOR function to derive the second hash value.

6. A method of preventing tampering of a firmware image on a computing device, the method comprising:
obtaining a first hash value of the firmware image;
selecting random blocks of real data from the firmware image;
selecting random blocks of fake data from the firmware image;
hashing the random blocks of real data, thereby obtaining hash values for the random blocks of real data;
hashing the random blocks of fake data, thereby obtaining hash values for the random blocks of fake data;
combining the hash values for the random blocks of real data and the hash values for the random blocks of fake data, thereby deriving a second hash value;
combining the first hash value and the second hash value;
digitally signing the final hash value; and
comparing the final hash value with a stored hash value.

7. A method as recited in claim 6 further comprising:
inserting a non-zero value in a register on the computing device if the final hash value is the same as the stored hash value.

8. A method as recited in claim 6 further comprising:
inserting a zero in a register on the computing device if the final hash value is not the same as the stored hash value.

9. A method as recited in claim 6 further comprising:
updating a bit map table to indicate the random blocks of data of the firmware image that were selected.

10. A method as recited in claim 6 wherein the hash values are logically combined using an XOR function to derive the second hash value.
